(19) United States
(12) Patent Application Publication
(10) Pub. No.: US 2022/0262268 A1
(43) Pub. Date: Aug. 18, 2022

(54) COMPUTER IMPLEMENTED DESCRIPTION ANALYSIS FOR TOPIC-DOMAIN MAPPING

(71) Applicant: The University of North Carolina at Greensboro, Greensboro, NC (US)

(72) Inventors: Somya D. MOHANTY, Greensboro, NC (US); Aaron BEVERIDGE, Greensboro, NC (US); Noel A. MAZADE, Greensboro, NC (US); Kimberly P. LITTLEFIELD, Greensboro, NC (US)

(21) Appl. No.: 17/675,115

(22) Filed: Feb. 18, 2022

Related U.S. Application Data
(60) Provisional application No. 63/150,766, filed on Feb. 18, 2021.

(51) Int. Cl. G09B 5/02; G06F 16/28; G06F 40/284; G06F 40/166; G06F 40/30

(52) U.S. Cl. CPC G09B 5/02; G06F 16/285; G06F 40/30; G06F 40/166; G06F 40/284

(57) ABSTRACT

In one aspect, a computer implemented modeling method for education course topic-domain mapping is disclosed. In the example, a computing device receives educational course data, such as course title and description. Next, the computing device prepares the course data and applies tokenization and or removes stop words. Next, the computing device generates a corpus from the prepared course data. Next, the computing device generates topic-level domains from the corpus. Next, the computing device evaluates and examines the similarity of the topic-domains to the corpus of information. The computing device then generates a graph of the topic-domains. Wherein within the generated graph the computing device identifies topic-domain groupings. Lastly, the computing device displays the graph with the topic-domain groupings.

### CROSS REFERENCE TO RELATED APPLICATIONS

The present application claims priority to U.S. Provisional Application Ser. No. 63/150,766, filed Feb. 18, 2021, the contents and substance of which are incorporated herein in their entirety.

### FIELD

The present disclosure relates to computer implemented systems and methods of natural language understanding, in particular the mapping of concepts using topic modeling and graph theory.

### BACKGROUND

Unsupervised learning from a collection of information, such as documents and course descriptions is fundamentally difficult to obtain meaningful information and/or understanding. A key problem in obtaining meaningful information is the ability to evaluate a corpus of information, and properly organize, and visualize the information. Topic modeling is a type of statistical modeling for discovering often abstract topics in a collection of information. Educational institutions, as well as learning providers and business providers for educational institutions, often curate or have programs, courses, and resources that cover a broad set of topics. Often times the relationships between these offerings is unknown. Further, course curriculum and or course topics in a variety of departments may overlap or have commonality that is not known. There is a need within the industry to understand course program overlap and to efficiently build connections within educational offerings to aid in instructional business intelligence.

### SUMMARY

In one aspect, a computer implemented modeling method for education course topic-domain mapping is disclosed. In the example, a computing device receives educational course data, such as course title and description. Next, the computing device prepares the course data and applies tokenization and removes stop words. Next, the computing device generates a corpus from the prepared course data. Next, the computing device generates topic-level domains from the corpus. Next, the computing device evaluates and examines the similarity of the topic-domains to the corpus of information. The computing device then generates a graph of the topic-domains. Wherein within the generated graph the computing device identifies topic-domain groupings. Lastly, the computing device displays the graph with the topic-domain groupings.

In another aspect, a computer implemented method for modeling and analyzing education course descriptions is disclosed. In this example, within the first stage a computing device receives data and preprocesses the data, or otherwise prepares the data and generates a corpus or text. In the second stage, the computing device generates topics from the corpus, wherein the topics are evaluated by perplexity. Next, the computing device generates topic similarity. In the third stage, of this example, the computing device creates a graph from the corpus and from the topics, whereby it groups or clusters the topics utilizing a Louvain method. Lastly, the computing device displays the generated groupings and identifies the topics groupings.

These and other embodiments are described in greater detail in the description which follows.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. In the drawings:

FIG. 1 illustrates a flow chart of an example method for topic-domain mapping;

FIG. 2 illustrates a flow chart of an example method for data cleanup for topic-domain mapping;

FIG. 3 illustrates an example of prior art of the Latent Dirichlet Allocation as applied to a corpus;

FIG. 4 illustrates an example overview of topic-domain mapping;

FIG. 5 illustrates an example graph of perplexity and coherence versus topic count;

FIG. 6 illustrates an example table of generated topics and descriptions;

FIG. 7 illustrates an example table of generated topics and Latent Dirichlet Allocation keywords and scores;

FIG. 8 illustrates an example of graph super topic grouping in topic-domain mapping;

FIG. 9 illustrates an example of Louvian Clustering of the topic-domain;

FIG. 10 illustrates an example of topic-domain graph and clustering;

FIG. 11 illustrates an additional example of a topic-domain graph and clustering;

FIG. 12 illustrates an example of a computing device;

FIG. 13 illustrates an example of Latent Dirichlet Allocation applied to the disclosure herein.

FIG. 14 illustrates a flow chart depicting an example embodiment in accordance with the present disclosure.

### DETAILED DESCRIPTION

Implementations and embodiments described herein can be understood more readily by reference to the following detailed description, drawings, and examples. Elements, apparatus, and methods described herein, however, are not limited to the specific implementations presented in the detailed description, drawings, and examples. It should be recognized that these implementations are merely illustrative of the principles of the present disclosure. Numerous modifications and adaptations will be readily apparent to those of skill in the art without departing from the spirit and scope of the disclosure.

Topic models are a statistical language model that is often useful in uncovering hidden structure in a collection of documents or texts. For example, discovering hidden themes within a collection of documents, or classifying documents into discovered themes, or using the classification to organize documents. In one aspect, topic modeling is dimensionality reduction followed by applying a clustering algorithm. In one example the topic model engine would build clusters of words, rather than clusters of text. It can be thought of a text as having all the topics, wherein the topics are each assigned a specific weight.

One example of a package for topic modeling is GENSIM, available at https://radimrehurek.com/gensim/index.html. Another example of a relevant package is the Natural Language Toolkit (NLTK), allowing for text processing capabilities such as classification, tokenization, stemming, tagging, parsing, semantic reasoning, and more. There are other packages, and the one provided herein is for explanation and non-limiting. These packages merely aid the disclosure herein and are examples. In this disclosure the packages, libraries, and concepts may be modified to produce intended results.

Latent Dirichlet Allocation (LDA) is a generative statistical model that allows sets of observations to be explained by unobserved groups that explain why some parts of the data are similar. In one example, if observations are words collected in a corpus, LDA posits that each document in the corpus is a mixture of a small number of topics, and that each word's presence is attributable to one of the document's topics.

Non-negative matrix factorization (NNMF), also non-negative matrix approximation is a group of algorithms in multivariate analysis and linear algebra where a matrix V is typically factorized into two matrices W and H, with the property that all three matrices have no negative elements. This non-negativity makes the resulting matrices easier to inspect. NNMF has an inherent clustering property, and it automatically clusters columns of input data. In one aspect, the NNMF may be used in conjunction with term frequency-inverse document frequency (TF-IDF) to perform topic modeling. TF-IDF is a numerical statistic that reflects how important a word is to a document in a corpus.

Latent Semantic Analysis (LSA) is a technique in natural language processing of analyzing relationships between a corpus and the terms contained within the corpus. Wherein the LSA produces a set of concepts related to the documents and terms. LSA assumes that words that are close in meaning will occur in similar pieces of text. Singular Value Decomposition (SVD) may also be applied to LSA reduce the number of unique words while preserving the similarity structure. An example of LSA being applied to information retrieval is found in U.S. Pat. No. 4,839,853, titled computer information retrieval using latent semantic structure.

In one aspect, the computer implemented description analysis for topic-domain mapping may be used to map high level concepts to textual descriptions for educational courses or programs. In this aspect, a multi-level aggregation and mapping of text to concepts using topic modeling and graph theory is applied. The topic modeling utilizes a generative approach to create a distribution of topics over words present in the descriptions, for instance course descriptions. Next, the similarity between the topics and course descriptions is used to construct a graph. Wherein utilization of a sub-graph community detection is used to identify clusters of topics (super topics) and courses which are highly interrelated. These processes, and others may be modified by adjusting parameters to deliver optimal results.

In another example, a group of educational institutions may combine course descriptions and map high level concepts to textual descriptions, allowing for further analysis of group educational offerings. For example, a state university system may be able to utilize the disclosure herein to map and understand offerings within the state educational system to deliver business management benefits. In one aspect, the technology may be shared so that various institutions within a university system may collaborate on course offerings or course developments. Further, information gathered from the disclosure herein may further assist with course planning, or facilitate transfer credit opportunities for collateral courses at other institutions. Even further, certain aspects may provide research and collaboration insights for opportunities for applying similar research goals or identifying individuals (such as professors, or graduate students) with interests that may align for further research or technology development.

In one aspect, a computing device applies the LDA algorithm, training a model on the corpus of data science course descriptions. The generative model is evaluated, and the coherence and perplexity is determined for a set level of topics. In the example, once the course descriptions are mapped to topics, and weighted, the courses are graphed. Wherein at the graph stage the various nodes are then clustered into communities by applying Louvain clustering. In other aspects additional clustering may be applied (K-Means, K-NN) and or dimensionality reduction may be applied through principal component analysis (PCA), independent component analysis (ICA), NNMF, kernel PCA, or other graph based PCA. Further, both hard and soft clustering algorithms are applicable and the benefits of each are dependent upon the topical area. In the example of Louvain clustering for maximization of modularity the following formulae may be applied: Q=1wΣ_{i,j}(Aᵢⱼ−γ*dᵢdⱼ/w)δcᵢcⱼ. Wherein parameters such as resolution, modularity, optimization, minimum aggregation, maximum aggregation, shuffle, sort, are applicable and may be configured per graph. Further, configurable variables may include labels, membership, and adjacency, to name a few. Wherein, upon clustering the computing device displays the graph indicating the various groups or clusters of topics and identifying within the data concepts that can lead to business intelligence results.

According to certain aspects of the present disclosure, an exploratory analysis can be performed. One example aspect of an exploratory analysis can include generating one or more statistical properties (e.g., mean, mode, standard deviation, percentile, etc.) characterizing a dataset. For example, according to certain implementations of the disclosure, a word cloud can be generated from a dataset. The word cloud can then be processed visually by a person, computationally utilizing one or more machine-learned models, or both. In some implementations, a method disclosed herein can also include performing an exploratory analysis by processing a word cloud.

Another example aspect of the disclosure is related to optimization of LDA models for processing educational course data. For example, LDA models can include different inference methods for determining probability distributions a word is associated with a topic. In some implementations, the LDA model can include a Baysean approximation. Alternatively or additionally, the LDA model can include a Monte Carlo simulation to approximate the probability.

According to example aspects of the present disclosure, LDA models can also include parameters for the number of topics. In some implementations, the number of topics can be a set value (e.g., 5-50). Alternatively, the number of topics may be determined based on a characteristics of the dataset provided to the model (e.g., word count, number of unique words, etc.). By modifying the number of topics, a better probability for assigning a word to a topic can be determined. However, it should be understood that very high number of topics can result in overfitting that provides less understanding of how words are grouped and lower numbers of topics can result in underfitting that does not capture distinction between words.

In some implementations, determining an optimum number of topics can be based on iteratively running the model and modifying at least the number of topics. For instance, the perplexity and/or coherence values of the model may be used to characterize the accuracy of the model for assigning a word to a topic.

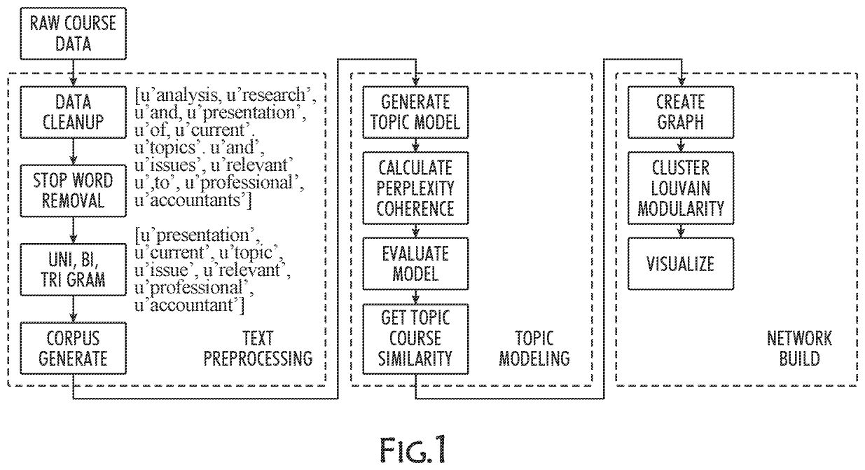

Referring now to FIG. 1, in the example the method disclosed herein is bifurcated into three stages. In other examples the method and or process may be one single stage, or any number of stages. In the example, raw course data or course data is received by a computing device, wherein data cleanup, preparation, and pre-processing occur. In this pre-processing stage an engine may exist that performs aspects of tokenization, lemmatization, stemming, and stop word removal. Next, phrase modeling, such as unigram, bigram, and trigram models may be applied, wherein one, two, or three words that frequently occur together in a document are built into the model. Additional levels such as quadgrams and more are also available depending on the corpus selected. At the end of the pre-processing or text pre-processing stage a corpus is formed. Wherein a corpus is a collection of documents or information.

In the second stage of our example, topic modeling occurs by the engine module computing a topic model by generating and training the model through LDA. In other aspects, other algorithms such as NNMF or LSA or pLSA is utilized. Further, the preprocessed data may have also been applied to TF-IDF to transform the corpus. Next, the engine calculates the perplexity and coherence. One such example is Coherence=Σ_{i<j}score(wᵢ, wⱼ) of pairwise scores on the words wᵢ, . . . wₙ used to describe the topic. Perplexity captures how surprised a model is of new data it has not seen before and is measured as the normalized log-likelihood of a held-out test set. In other words, it measures how probably some new unseen data is given the model that was learned. Coherence is defined as a set of statements or facts that support each other. A coherent fact set is a fact set that covers all or most of the facts. There are a variety of coherence measures, and each one may be customized or tailored to a given model. Such measures may assist in adjusting parameters for the topic model. Next, in our example, the model is evaluated, wherein the generative process of the topic model continues. At the end of the second state, topic modeling, the computing device generates a topic to words/token (in corpus) distribution and a course to topic similarity score where a course has a distribution of topic scores associated with it. The computing device then utilizes the scores to index topics to courses.

At the third stage, in our example, a graph is created through use of the topic course similarity, wherein clustering is applied. Clustering is a task of grouping a set of objects in such a way that the objects in the same group (cluster) are more similar to each other than those in other groups (clusters). The Louvain method for community detection, or Louvain method is a method to extract communities from large networks. It is a greedy optimization method. In the Louvain method small communities are first detected by optimizing modularity locally on all nodes. Then, each small community is grouped into one node and the first step is repeated. In such a fashion, communities are amalgamated by those which produce the largest increase in modularity. In our example, the generated topics may then be graphed and clustered based on community. In another example, the computing device, within the third stage, represents the course and topic as a set of graph nodes, where the connecting edge between the nodes is weighted with the similarity score. Next, the Louvain method is applied to compute the clustering label on all nodes, where the approach detects sub-graph communities, i.e. the collection of courses and topics which are closely associated with each other.

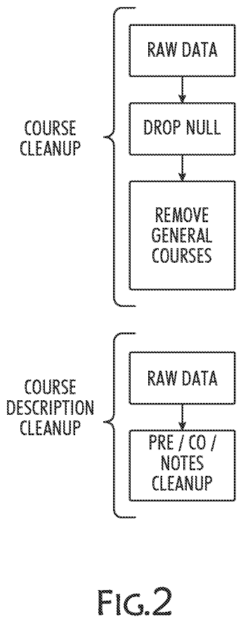

Referring now to FIG. 2, an example of the pre-processing stage is disclosed in the form of a flow chart. In the example the total number of courses is reduced through the process and course cleanup may include a variety of steps as previously disclosed.

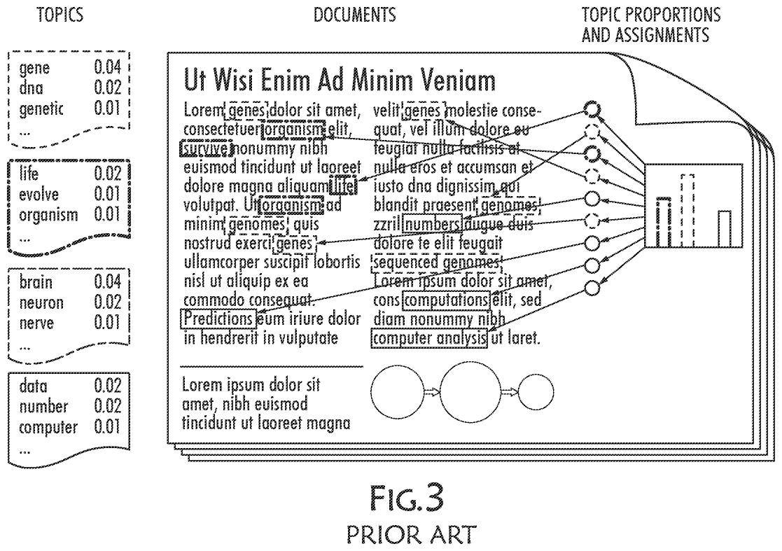

Referring now to FIG. 3, a prior art of an example of LDA is disclosed. In the example of topic modeling with LDA, the topics are generated with a score and the proportions and assignments of weights are calculated.

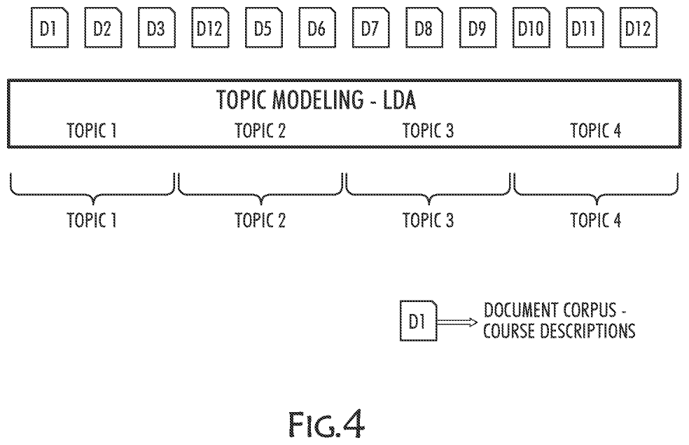

Referring now to FIG. 4, an example embodiment is depicted where D1-D12 represent documents in the corpus. Wherein LDA is applied and generates four topics. In other aspects any number of topics may be generated. Depending upon the corpus size, topics may be structured, for example with course descriptions, a topic size may be broken into available departments, or available sub departments to allow for topics identifying with various school departments.

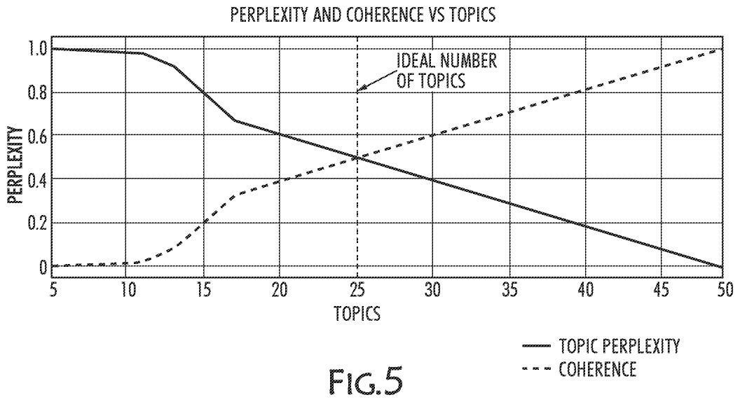

Referring now to FIG. 5, an example graph showing perplexity and coherence versus the topic count is identified. Optimal selection of topic count is one parameter among many that may be modified to improve results. In some implementations, for example as illustrated here, the optimal or ideal topic count parameter can be determined based at least in part on the difference between the perplexity and coherence values. In some implementations, the ideal number of topics is determined based on the intersection of the perplexity and coherence values (e.g., when the difference is about zero).

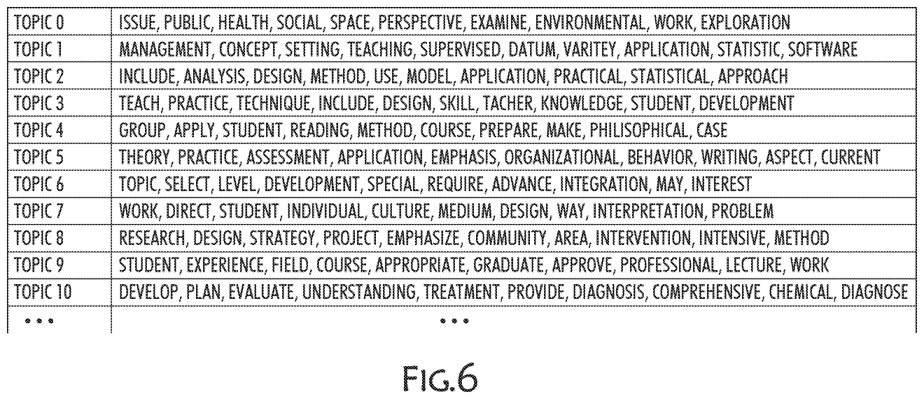

Referring now to FIG. 6, a sample of generated topics and descriptions are provided, wherein the topics have identified through the generative process of applying LDA and evaluating the results, training the model and configuring the parameters to produce optimal results in relation to the perplexity coherence. As should be understood, these topics are illustrative and based on the corpus of data provided to the model. In some implementations, the model may be defined so that for each topic, the associated description includes a number of terms such as 5-20 (e.g., 10). According to certain example models herein, the number of terms can be the same for each topic or the number can vary.

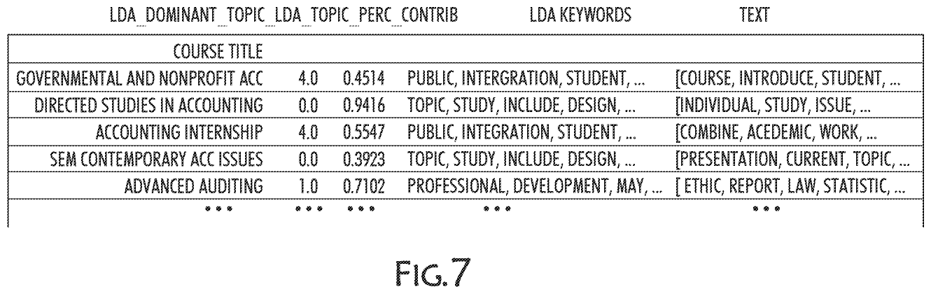

Referring now to FIG. 7, an example table of generated topics and LDA keywords and scores is provided. More particularly, in certain example implementations, methods can be used to generate topic an keywords based on data such as educational courses (each associated with a course title) and descriptions associated with the educational course. According to certain embodiments of the disclosure, this information can be provided to model as raw data (e.g., raw course data) and the model return a table such as illustrated in FIG. 7. As should be understood, a table as illustrated need not necessarily be a direct output of the model, but may be produced as an intermediate output for application such as producing data used to produce a word cloud

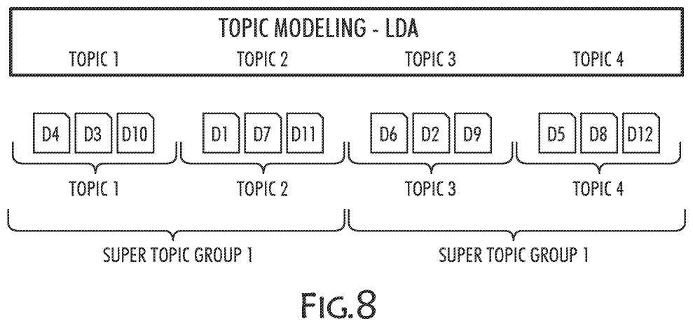

Referring now to FIG. 8, an example of an LDA topic to graph super topic-domain mapping is provided. As illustrated, a super topic can include one or more topics. In this manner, words and/or topics can be grouped hierarchically according to some example implementations of the present disclosure.

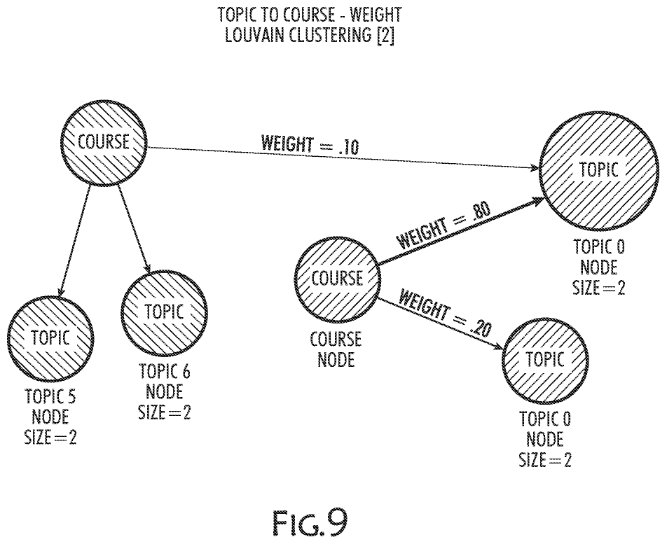

Referring now to FIG. 9, an example of Louvian Clustering of the topic-domain is provided. The image illustrates directional relationships between courses and topics that can be generated according to example implementations of the present disclosure.

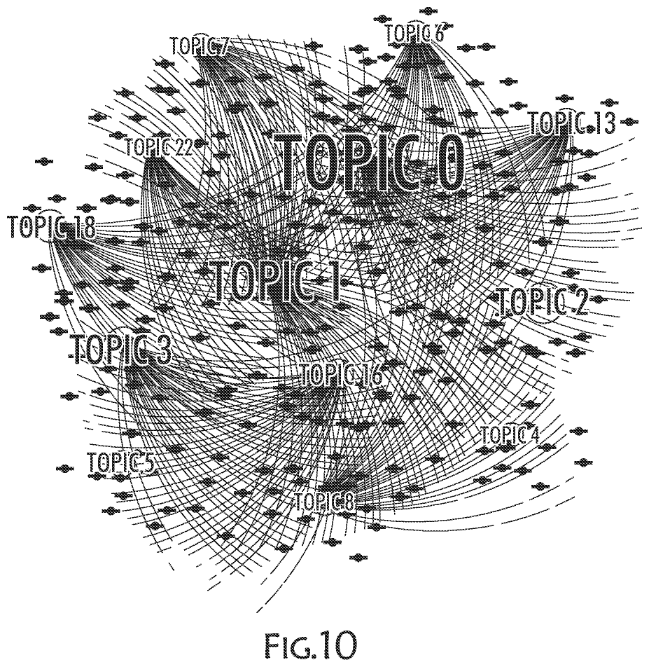

Referring now to FIG. 10, an example of topic-domain graph and clustering is provided. As illustrated higher densities or reduced distance between nodes can indicate similarity between nodes. According to example aspects of the present disclosure, each node can represent a word contained in the educational course data. Additional clustering algorithms such as kNN, GMM, Spectral Clustering, and OPTICS may be applied if Louvian Clustering is incompatible or performs sub optimally with the topic-domain.

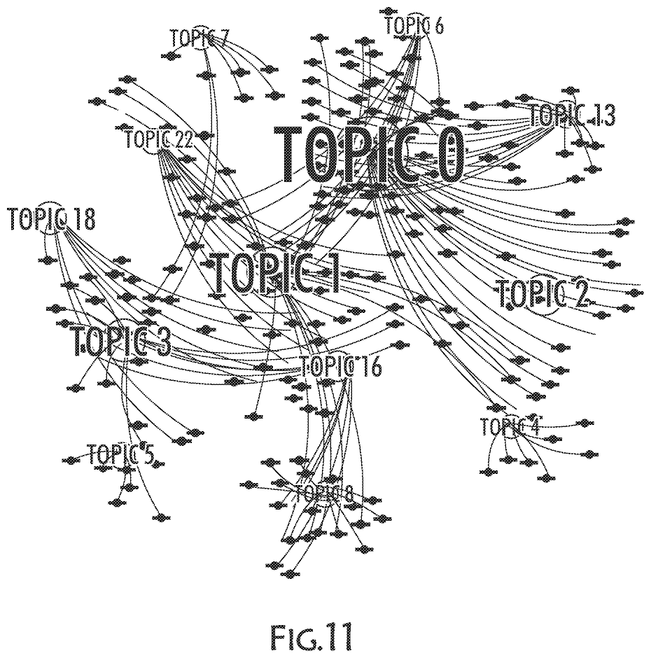

Referring now to FIG. 11, an additional example of a topic-domain graph and clustering is provided. In FIG. 11, the dataset is a subset of FIG. 10, but the model is reduced based on principal components analysis. Other reduction or noise clearing algorithms may be applied prior to clustering algorithm application

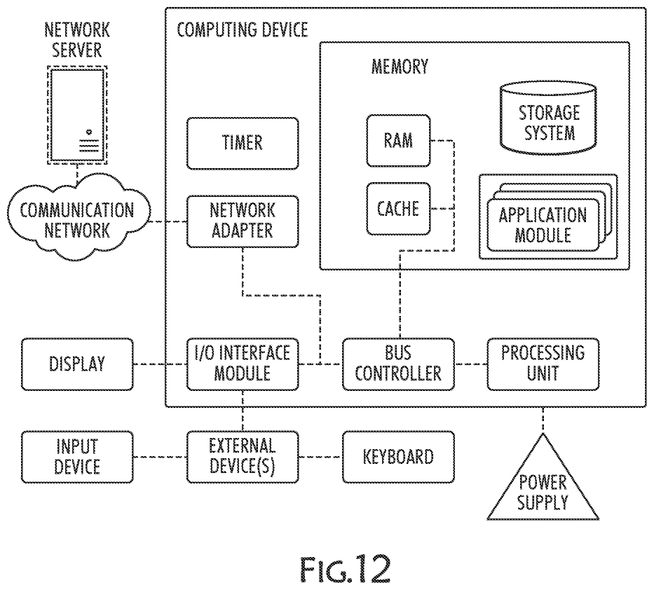

In the example of FIG. 12 a general-purpose computing device is disclosed. In other aspects a microcontroller may be adapted for specific elements of the disclosure herein or even further, a special purpose computing device may form elements of the disclosure. In the example embodiment of FIG. 12, the computing device is comprised of several components. In the example, the computing device is equipped with a timer. The timer may be used in applications such as applications for generating time delays for battery conservation or to control sampling rates, etc. The computing device is equipped with memory, wherein the memory contains a long-term storage system that is comprised of solid-state drive technology or may also be equipped with other hard drive technologies (including the various types of Parallel Advanced Technology Attachment, Serial ATA, Small Computer System Interface, and SSD). Further, the long-term storage may include both volatile and non-volatile memory components. For example, the processing unit and or engine of the application may access data tables (corpus) or information in relational databases or in unstructured databases within the long-term storage, such as an SSD. The memory of the example embodiment of a computing device also contains random access memory (RAM) which holds the program instructions along with a cache for buffering the flow of instructions to the processing unit. The RAM is often comprised of volatile memory but may also comprises nonvolatile memory. RAM is data space that is used temporarily for storing constant and variable values that are used by the computing device during normal program execution by the processing unit. Similar to data RAM, special function registers may also exist, special function registers operate similar to RAM registers allowing for both read and write. Where special function registers differ is that they may be dedicated to control on-chip hardware, outside of the processing unit.

Further disclosed in the example embodiment of FIG. 12, is an application module. The application module is loaded into memory configured on the computing device. The disclosure herein may form an application module and thus may be configured with a computing device to process programmable instructions. In this example, the application module will load into memory, typically RAM, and further through the bus controller transmit instructions to the processing unit. The processing unit, in this example, is configured to a system bus that provides a pathway for digital signals to rapidly move data into the system and to the processing unit. A typical system bus maintains control over three internal buses or pathways, namely a data bus, an address bus, and a control bus. The I/O interface module can be any number of generic I/O, including programmed I/O, direct memory access, and channel I/O. Further, within programmed I/O it may be either port-mapped I/O or memory mapped I/O or any other protocol that can efficiently handle incoming information or signals.

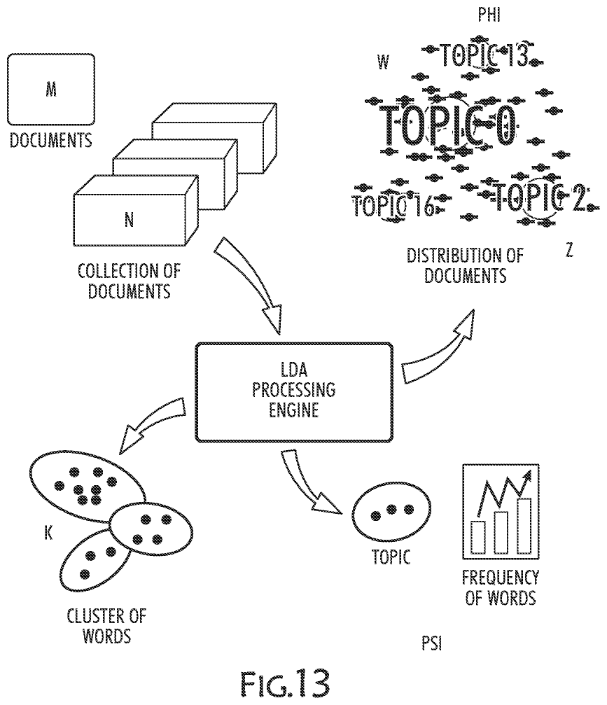

Referring now to FIG. 13, an example of Latent Dirichlet Allocation (LDA) is applied to the disclosure herein. In the example, documents form a corpus or collection of documents (M) with words (N). Wherein the LDA processing engine, or application engine, or engine, groups or clusters words (N) into topics (K). The clustered words (N) form topics (K) and the psi of (K) is the word distribution for topic (k). Therefore, in this example we can say that the generative process of LDA, given the number of documents (M), and the number of words within those documents (N), and the prior number of topics (K), the model trains and outputs, psi, the distribution of words for each topic K; and, phi, the distribution of topics for each document i.

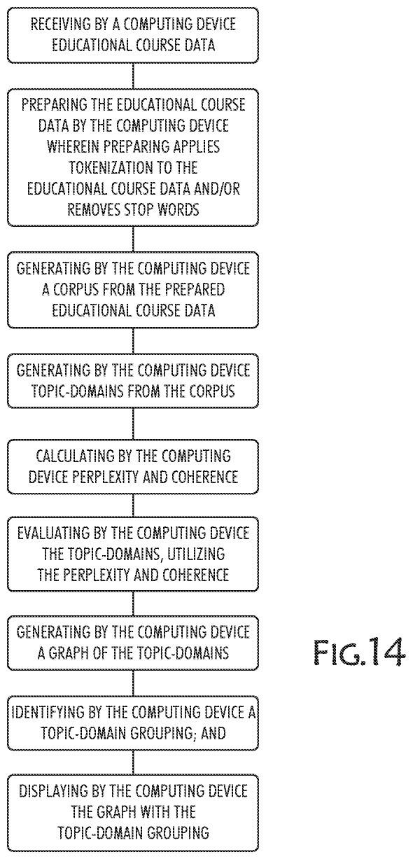

Referring now to FIG. 14, an example method for educational course topic-domain mapping is illustrated. While steps of the method are illustrated in a particular order, this does not necessitate that the steps must be performed in this order. Further, the computing device recited in the steps can include one or a plurality of computing devices. In some implementations, a plurality of computing devices can perform one or more steps of FIG. 14 in parallel.

More particularly, an example method as depicted in FIG. 14 can include receiving by a computing device educational course data; preparing the educational course data by the computing device wherein preparing applies tokenization to the educational course data and/or removes stop words; generating by the computing device a corpus from the prepared educational course data; generating by the computing device topic-domains from the corpus; calculating by the computing device perplexity and coherence; evaluating by the computing device the topic-domains, utilizing the perplexity and coherence; generating by the computing device a graph of the topic-domains; identifying by the computing device a topic-domain grouping; and displaying by the computing device the graph with the topic-domain groupings.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A computer implemented modeling method for educational course topic-domain mapping, comprising:
receiving by a computing device educational course data;
preparing the educational course data by the computing device wherein preparing applies tokenization to the educational course data and/or removes stop words;
generating by the computing device a corpus from the prepared educational course data;
generating by the computing device topic-domains from the corpus;
calculating by the computing device perplexity and coherence evaluating by the computing device the topic-domains, utilizing the perplexity and coherence;
generating by the computing device a graph of the topic-domains;
identifying by the computing device a topic-domain grouping; and
displaying by the computing device the graph with the topic-domain groupings.

2. The method of claim 1, wherein receiving by a computing device education course data comprises, the computing device receiving education course data from a plurality of uniform resource locators (URLs).

3. The method of claim 1, further comprising applying by the computing device lemmatization to the course data.

4. The method of claim 1, further comprising applying by the computing device stemming to the course data.

5. The method of claim 1, further comprising generating by the computing device a document-topic matrix.

6. The method of claim 1, further comprising generating by the computing device a topic-term matrix.

7. The method of claim 1, further comprising applying by the computing device Latent Dirichlet Allocation (LDA) on the corpus of information.

8. The method of claim 1, further comprising applying by the computing device Latent Semantic Analysis (LSA) on the corpus of information.

9. The method of claim 1, further comprising applying by the computing device a Probabilistic Latent Semantic Analysis (pLSA) on the corpus of information.

10. The method of claim 1, further comprising applying a Louvain method on the graph of the topic-domains.

11. The method of claim 1, further comprising an exploratory analysis by processing a word cloud.

12. A computer implemented modeling method for analyzing educational course descriptions, comprising:
implementing a first stage on a computing device, comprising:
receiving data;
preprocessing the data, wherein preprocessing prepares the data for topic modeling;
generating a corpus;
implementing a second stage on the computing device, comprising:
generating topics;
evaluating the generated topics;
generating topic similarity;
implementing a third stage on a computing device, comprising:
creating a graph from the corpus and from the topics;
grouping the topics from the graph; and
displaying the grouped topics on the graph.

13. The method of claim 12, wherein receiving the data, the computing device receives data from a plurality of uniform resource locators (URLs) at the first stage.

14. The method of claim 12, further comprising applying by the computing device lemmatization to the course data at the first stage.

15. The method of claim 12, further comprising applying by the computing device stemming to the course data at the first stage.

16. The method of claim 12, further comprising generating by the computing device a document-topic matrix at the first stage.

17. The method of claim 12, further comprising generating by the computing device a topic-term matrix at the second stage.

18. The method of claim 12, further comprising applying by the computing device Latent Dirichlet Allocation (LDA) on the corpus of information at the second stage.

19. The method of claim 12, further comprising applying by the computing device Non-negative matrix factorization (NNMF) on the corpus of information at the second stage.

20. The method of claim 12, further comprising applying by the computing device Latent Semantic Analysis (LSA) on the corpus of information at the second stage.

21. The method of claim 12, further comprising applying a Louvain method on the graph at the third stage.
